(19) United States
(12) Patent Application Publication
(10) Pub. No.: US 2026/0135285 A1
(43) Pub. Date: May 14, 2026

(54) LED LUMINOUS ANTENNA AND DEVICE COMPRISING THE SAME

(71) Applicant: Jiangxi Innovation Technology Co., Ltd, Ji'an City (CN)

(72) Inventors: Xiaobing Liu, Ji'an (CN); Qin Li, Ganzhou (CN)

(73) Assignee: Jiangxi Innovation Technology Co., Ltd, Ji'an City (CN)

(21) Appl. No.: 19/237,105

(22) Filed: Jun. 13, 2025

(30) Foreign Application Priority Data
Nov. 11, 2024 (CN) 202422737860.5

(51) Int. Cl. H01Q 1/06; F21S 4/28; F21V 23/00; F21Y 103/10; F21Y 115/10

(52) U.S. Cl. CPC H01Q 1/06; F21S 4/28; F21V 23/002; F21Y 2103/10; F21Y 2115/10

(57) ABSTRACT

An LED luminous antenna is provided, including a circuit board, an antenna element, and multiple LED beads. The antenna element is flat-shaped and is laid on a front of the circuit board, and a feeding point of the antenna element is located on the circuit board where below a centerline of the antenna element. The multiple LED beads are arranged along an edge of a front projection of antenna element and disposed on the circuit board, and a connecting wire between the multiple LED beads is arranged on a back of the circuit board. The circuit board is provided with a light bead control connection point for external devices to power supply and control the LED beads. The antenna can reduce the impact on the performance of antenna element, ensuring sufficient power supply for the LED beads and giving them strong luminous brightness.

### TECHNICAL FIELD

The present disclosure relates to the technical field of antenna structures, and in particular to an LED luminous antenna and device comprising the same.

### BACKGROUND

Chinese patent CN203553326U discloses a luminous antenna structure, which mainly includes a base, a diversion group disposed on the base, a transmitting and receiving wave group disposed on the diversion group, a luminescent group disposed on a metal wire body of the transmitting and receiving wave group, and transparent outer tube inserted on the transmitting and receiving wave group. Among them, the transmitting and receiving wave group mainly uses light-emitting diodes to emit light, which are crossed over the metal wire body through wires.

The light-emitting diodes with the above structure are powered by a metal wire body, which only generates a small current when working as an antenna and cannot provide sufficient power. At the same time, the metal wire body is long circle strip-shaped and it is difficult to across a large number of light-emitting diodes thereon, resulting in low overall luminous brightness. In addition, the placement of the light-emitting diodes across the metal wire body may easily affect the performance of the metal wire body as antennas for transmitting radio waves.

### SUMMARY

Given the shortcomings of existing technologies, the present disclosure aims to provide an LED luminous antenna with high luminous brightness and minimal impact on antenna performance.

To achieve the above objectives, the present disclosure adopts the following technical solutions.

In a first aspect, in some embodiments of the present disclosure, an LED luminous antenna is provided, including a circuit board, an antenna element, and multiple LED beads. The antenna element is flat-shaped and is laid on a front of the circuit board, and a feeding point of the antenna element is located on the circuit board where below a centerline of the antenna element. The multiple LED beads are arranged along an edge of a front projection of antenna element and disposed on the circuit board, and a connecting wire between the multiple LED beads is arranged on a back of the circuit board. The circuit board is provided with a light bead control connection point for external devices to power supply and control the LED beads.

In some preferred embodiments of the present disclosure, the circuit board is configured as a rectangular long strip, the antenna element is laid on an upper part of the circuit board, and the antenna element is provided with a hollow installation position for installing the LED beads.

In some preferred embodiments of the present disclosure, an edge contour shape of the antenna element below the feeding point is Y-shaped.

In some preferred embodiments of the present disclosure, the connecting wire of the LED beads located on a back of the antenna element is routed along an edge of the circuit board.

In some preferred embodiments of the present disclosure, a ratio of a specification width of the LED beads to a width of the antenna element is no more than ⅕.

In some preferred embodiments of the present disclosure, the multiple LED beads are divided into two groups, one group of the LED beads is arranged on the front of the circuit board, and another group of the LED beads is arranged on the back of the circuit board.

In some preferred embodiments of the present disclosure, the LED beads arranged on the front of the circuit board are located on one side of the circuit board, and the LED beads arranged on the back of the circuit board are located on an opposite side of the circuit board.

In some preferred embodiments of the present disclosure, each group of the LED beads is divided into two subgroups, and the two subgroups of the LED beads are located on left and right sides of the circuit board.

In a second aspect, in some embodiments of the present disclosure, an LED luminous antenna device is provided, including a connecting base and a diffusion tube disposed on the connecting base. The connecting base is provided with an antenna coaxial line and a connection line terminal for supplying power and controlling the LED beads. In addition, the LED luminous antenna device further includes the LED luminous antenna described above, the LED luminous antenna is place within the diffusion tube, an end of the antenna coaxial line is electrically connected to the feeding point of the antenna element, and the connection line terminal is electrically connected to the light bead control connection point.

In some preferred embodiments of the present disclosure, the diffusion tube includes an inner diffusion tube and an outer diffusion tube, and the LED luminous antenna is placed within the inner diffusion tube.

The LED luminous antenna of the present disclosure has at least the following beneficial effects. By setting the antenna element and the multiple LED beads on the circuit board, where the LED beads are arranged along the edge of the front projection of the antenna element, so that there is enough space to arrange a large number of LED beads, while reducing the impact on the performance of the antenna element. In addition, the circuit board is provided with the light bead control connection point, and the external devices can provide separate power supply and control for the LED beads during use, ensuring that the LED beads have sufficient power supply and strong luminous brightness.

### BRIEF DESCRIPTION OF THE DRAWINGS

FIG. 1 shows a front view of a LED luminous antenna in accordance with some embodiments of the present disclosure.

FIG. 2 shows an enlarged schematic diagram of part A in FIG. 1.

FIG. 3 shows a front view of an antenna element in accordance with some embodiments of the present disclosure.

FIG. 4 shows a structural schematic diagram of an LED luminous antenna device in accordance with some embodiments of the present disclosure.

FIG. 5 shows an enlarged schematic diagram of part B in FIG. 4.

FIG. 6 shows a structural schematic diagram of the LED luminous antenna device after removing a diffusion tube and a partially enlarged view thereto.

### DETAILED DESCRIPTION OF THE EMBODIMENTS

The following will provide a clear and complete description of the concept, specific structure, and technical effects of the present disclosure in conjunction with the embodiments and accompanying drawings, to fully understand the purpose, features, and effects of the present disclosure. All technical features in the present disclosure can be combined with each other in an interactive manner, provided that they do not contradict or conflict with each other.

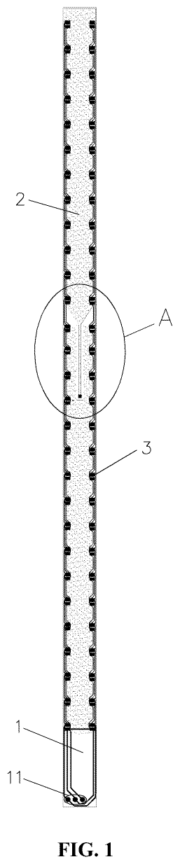

Referring to FIG. 1 to FIG. 3, in some embodiments of the present disclosure, an LED luminous antenna is provided, including a circuit board 1, an antenna element 2, and multiple LED beads 3. Herein the circuit board 1 uses PCB board or FPC board as the substrate for carrying the antenna element 2 and the LED beads 3. The antenna element 2 is flat-shaped and is laid on a front of the circuit board 1, and a feeding point 21 of the antenna element 2 is located on the circuit board 1 where below a centerline of the antenna element 2.

The multiple LED beads 3 are arranged along an edge of a front projection of antenna element 2 and disposed on the circuit board 1. The multiple LED beads 3 are divided into two groups, one group of the LED beads 3 is arranged on the front of the circuit board 1, and another group of the LED beads 3 is arranged on the back of the circuit board 1. From the front projection, the two groups of the LED beads 3 are arranged along the edge of the antenna element 2, which can reduce the impact on the antenna performance of the antenna element 2 and provide sufficient space for arrangement along the edge of the antenna element 2.

A connecting wire between the multiple LED beads 3 is arranged on the back of the circuit board 1, and the circuit board 1 is provided with a light bead control connection point 11, including power connection points and control signal connection points, for external devices to provide separate power supply and control to the LED beads 3. The power connection between the antenna element 2 and the LED beads 3 is separated, which can avoid mutual interference between the two. Furthermore, the LED beads with driver chips are selected for the LED beads 3, which can facilitate the diversity of light effects and also reduce the use of surrounding components. The ratio of a specification width of the LED beads 3 to a width of the antenna element 2 is no more than ⅕, so that the specification width of the LED beads 3 will not be too large, thereby reducing the impact on antenna performance.

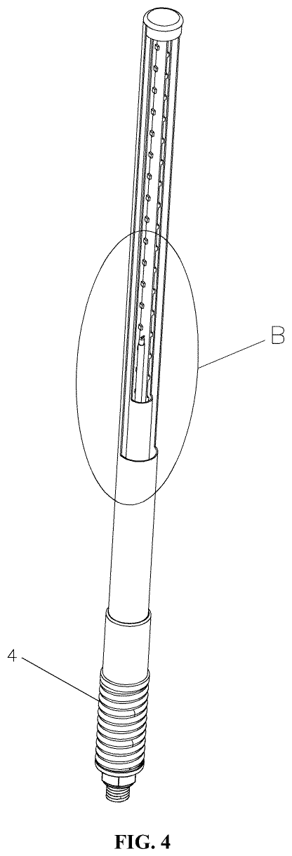

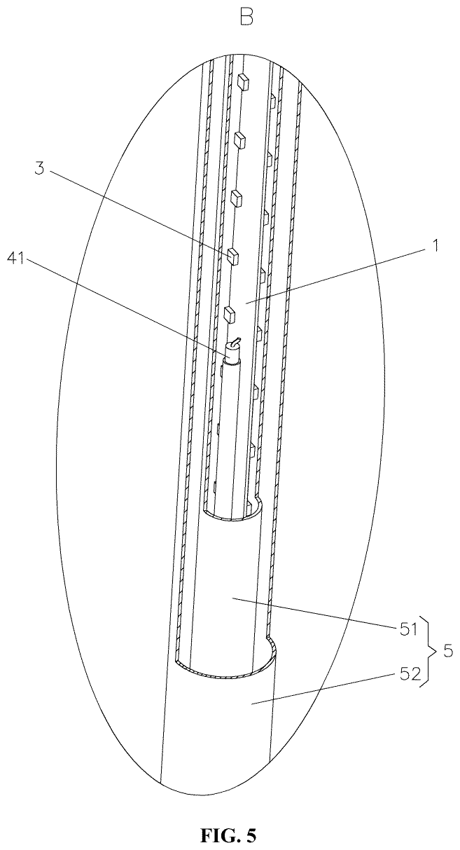

In some embodiments of the present disclosure, referring to FIG. 4 and FIG. 5, the LED beads 3 arranged on the front of the circuit board 1 are mainly located on a left side of the circuit board 1, and the LED beads 3 arranged on the back of the circuit board 1 are mainly located on a right side of the circuit board 1. Of course, the front LED beads 3 may also be placed on the right side of the circuit board 1, while the back LED beads 3 may also be placed on the left side of the circuit board 1. Two groups of the LED beads 3 are located on opposite sides, which can facilitate the arrangement of the LED beads 3.

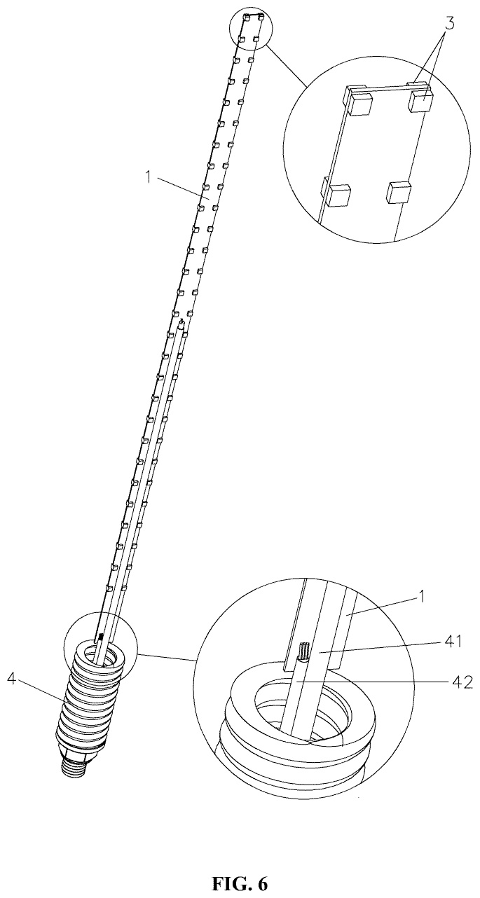

In some embodiments of the present disclosure, each group of the LED beads 3 is divided into two subgroups. Referring to FIG. 6, the LED beads 3 arranged on the front of the circuit board 1 is divided into two subgroups, and the two subgroups of the LED beads 3 are located on left and right sides the front of the circuit board 1 respectively. The LED beads 3 arranged on the back of the circuit board 1 is also divided into two subgroups, and the two subgroups of the LED beads 3 are located on left and right sides the back of the circuit board 1 respectively. The arrangement of the LED beads 3 can accommodate more quantities, and the LED beads 3 arranged on both sides to make the light emission more uniform.

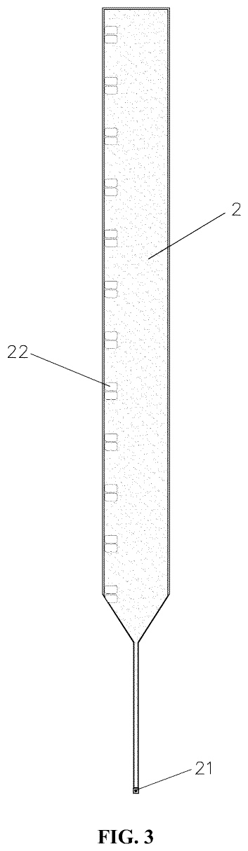

In some embodiments of the present disclosure, the circuit board 1 is configured as a rectangular long strip, and the antenna element 2 is laid on a front of an upper part of the circuit board 1. Under this structure, the antenna element 2 is provided with a hollow installation position 22 for installing the LED beads 3, as shown in FIG. 3. If only one group of the LED beads 3 is set on the left side, then the antenna element 2 is only provided with the hollow installation position 22 on the left side. If there are one group on both sides of the LED beads 3, then both sides of the antenna element 2 are provided with the hollow installation position 22.

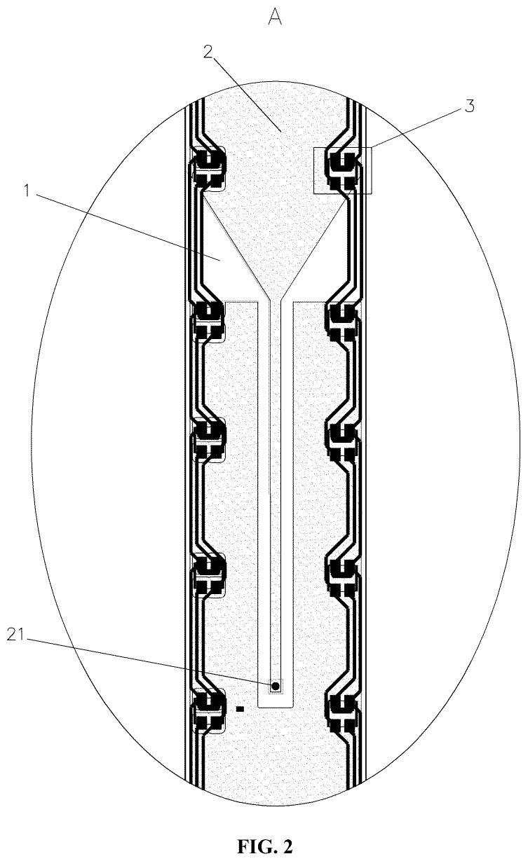

Referring to FIG. 1 and FIG. 2, the antenna element 2 is disposed on the upper part of the circuit board 1, with the feeding point 21 of the antenna element 2 below the centerline. An edge contour shape of the antenna element 2 below the feeding point 21 is Y-shaped gradient, which effectively avoids the impact of the wiring of the connecting wire of the LED beads 3 on antenna performance. Furthermore, the connecting wire of the LED beads 3 located on the back of the antenna element 2 is routed along the edge of the circuit board 1, creating coupling with the antenna element 2 and optimizing impedance while also increasing bandwidth.

Referring to FIG. 4, FIG. 5 and FIG. 6, in some embodiments of the present disclosure, an LED luminous antenna device is provided, including a connecting base 4 and a diffusion tube 5, the diffusion tube 5 is fixedly connected on the connecting base 4. The connecting base 4 is further provided with an antenna coaxial line 41 and a connection line terminal 42. In addition, the LED luminous antenna device further includes the LED luminous antenna described above, the LED luminous antenna is place within the diffusion tube 5, an end of the antenna coaxial line 41 is electrically connected to the feeding point 21, and signals are transmitted to the antenna element 2 through the antenna coaxial line 41. The antenna coaxial line 41 is arranged at the centerline position of the circuit board 1 to avoid blocking the light emission of the LED beads 3. The connection line terminal 42 is electrically connected to the light bead connection point 11. After the connecting base 4 is connected to the external devices, the LED beads 3 can be powered and controlled through the connection line terminal 42.

In some preferred embodiments of the present disclosure, referring to FIG. 4 and FIG. 5, the diffusion tube 5 includes an inner diffusion tube 51 and an outer diffusion tube 52, and the LED luminous antenna is placed within the inner diffusion tube 51. By using double-layer diffusion tube 5, the light emitted by the LED beads 3 is more uniform and the lighting effect is better.

In the present disclosure, the terms “first”, “second”, and “third” are only used for descriptive purposes and cannot be understood as indicating or implying relative importance. The term “multiple” refers to two or more, unless otherwise specified. The terms “installation”, “connection”, “connect”, and “fixation”, etc. should be broadly understood. For example, “connection” may be a fixed connection, a detachable connection, or an integrated connection. “Connect” may be directly connected or indirectly connected through an intermediate medium. For one of ordinary skill in the art, specific meanings of the above terms in the present disclosure can be understood according to the specific situation.

In the description of the present disclosure, it should be understood that the terms “up”, “down”, “left”, “right”, “front”, and “back”, etc. indicate orientation or positional relationships based on the orientation or positional relationships shown in the accompanying drawings. They are only for the convenience of describing the present disclosure and simplifying the description, and do not indicate or imply that the device or unit referred to must have a specific orientation, be constructed and operated in a specific orientation. Therefore, they cannot be understood as limiting the present disclosure.

In the description of the present disclosure, the terms “one embodiment”, “some embodiments”, “specific embodiments”, etc. refer to the specific features, structures, materials, or characteristics described in conjunction with the embodiments or examples included in at least one embodiment or example of the present disclosure. In this specification, the illustrative expressions of the above terms may not necessarily refer to the same embodiments or examples. Moreover, the specific features, structures, materials, or characteristics described can be combined in any one or more embodiments or examples in a suitable manner.

It should be noted that the above is only a further explanation of the present disclosure based on the embodiments, and does not constitute a limitation on the scope of protection of the present disclosure. if simple modifications are made to the present technology, they will only achieve the purpose of the present disclosure by basically the same means, and shall all fall within the scope of protection of the present invention.

What is claimed is:

1. An LED luminous antenna, comprising a circuit board, an antenna element, and multiple
LED beads;
wherein the antenna element is flat-shaped and is laid on a front of the circuit board, and a feeding point of the antenna element is located on the circuit board where below a centerline of the antenna element;
wherein the multiple LED beads are arranged along an edge of a front projection of antenna element and disposed on the circuit board, and a connecting wire between the multiple LED beads is arranged on a back of the circuit board; and
wherein the circuit board is provided with a light bead control connection point for external devices to power supply and control the LED beads.

2. The LED luminous antenna according to claim 1, wherein the circuit board is configured as a rectangular long strip, the antenna element is laid on an upper part of the circuit board, and the antenna element is provided with a hollow installation position for installing the LED beads.

3. The LED luminous antenna according to claim 2, wherein an edge contour shape of the antenna element below the feeding point is Y-shaped.

4. The LED luminous antenna according to claim 2, wherein the connecting wire of the LED beads located on a back of the antenna element is routed along an edge of the circuit board.

5. The LED luminous antenna according to claim 2, wherein a ratio of a specification width of the LED beads to a width of the antenna element is no more than ⅕.

6. The LED luminous antenna according to claim 1, wherein the multiple LED beads are divided into two groups, one group of the LED beads is arranged on the front of the circuit board, and another group of the LED beads is arranged on the back of the circuit board.

7. The LED luminous antenna according to claim 6, wherein the LED beads arranged on the front of the circuit board are located on one side of the circuit board, and the LED beads arranged on the back of the circuit board are located on an opposite side of the circuit board.

8. The LED luminous antenna according to claim 6, wherein each group of the LED beads is divided into two subgroups, and the two subgroups of the LED beads are located on left and right sides of the circuit board respectively.

9. An LED luminous antenna device, comprising a connecting base and a diffusion tube disposed on the connecting base; wherein the connecting base is provided with an antenna coaxial line and a connection line terminal for supplying power and controlling the LED beads; and
wherein the LED luminous antenna device further comprises the LED luminous antenna according to claim 1, the LED luminous antenna is place within the diffusion tube, an end of the antenna coaxial line is electrically connected to the feeding point of the antenna element, and the connection line terminal is electrically connected to the light bead control connection point.

10. The LED luminous antenna device according to claim 9, wherein the diffusion tube comprises an inner diffusion tube and an outer diffusion tube, and the LED luminous antenna is placed within the inner diffusion tube.
